(19) United States
(12) Patent Application Publication
(10) Pub. No.: US 2007/0210182 A1
(43) Pub. Date: Sep. 13, 2007

(54) System and Method for Monitoring Performance of a Spraying Device

(75) Inventors: Lieven Wulteputte, Melle (BE); Herman Ramon, Gent (BE); Jan Anthonis, Haasrode (BE); Bart De Ketelaere, Boechoot (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 11/749,469

(22) Filed: May 16, 2007

Related U.S. Application Data
(63) Continuation-in-part of application No. 11/114,449, filed on Apr. 26, 2005.

(51) Int. Cl. B67D 5/08

(52) U.S. Cl. 239/71; 239/398; 700/244

(57) ABSTRACT

A spraying device that sprays of a mixture of fluids is monitored to determine whether it is functioning properly. The spraying device has inlets for at least two fluids, such as water and air, and a mixing chamber in which the fluids are mixed. A mixture pressure sensor is mounted on the spraying device to detect the pressure of the mixture. The input pressures of the fluids entering the spraying device are also measured. A formula having left- and right-hand sides is provided for describing a relationship between the actual mixture pressure and the actual pressures of the first and second fluids. Based on the relationship provided by the formula, a comparison process is used to determine whether the spraying device is functioning properly.

### FIELD OF THE INVENTION

The invention concerns spraying devices such as nozzles, and more particularly to a system and method for monitoring the performance of a spraying device.

### BACKGROUND OF THE INVENTION

Spraying devices such as nozzles are widely used in a variety of industrial applications. In many applications, the proper performance of spraying devices is critical to the processing in which the sprays are used. The failure of a spraying device may result in defective products and cause potentially significant economic losses.

For instance, in the steel industry, spray nozzles of an internal-mixing type are used for steel cooling in a continuous casting process. An internal-mixing nozzle used in such a casting application provides a spray of a mixture of water and air, i.e., a mist. To that end, the spray nozzle has an internal mixing chamber, and water and air inlets with calibrated orifices. Water and air are fed through the inlet orifices into the internal mixing chamber, where they are mixed. The mixture is transported through a tube to a nozzle aperture that discharges the mixture in a desired spray pattern, such as a flat pattern. The spray generated by the nozzle is a function of the input water and air pressures, which may be set at different values for different applications depending on the particular requirements of the applications. For the nozzle to function properly, the input air and pressures have to be tightly controlled. Doing so, however, is not sufficient to guarantee the proper operation of the nozzle, because the air and water inlet orifices and the nozzle tip may become worn due to use or clogged, thereby preventing the nozzle from generating the desired spray output. Such performance degradation or malfunction of the internal-mixing spray nozzles can develop gradually overtime and has been difficult to monitor or detect.

### SUMMARY OF THE INVENTION

In view of the foregoing, it is an object of the invention to provide a reliable way to effectively monitor the performance of a spraying device, especially an internal-mixing spray nozzle, to ensure that it is functioning properly over the course of usage.

It is a related object to detect any significant performance degradation or malfunction of a spraying device, such as an internal-mixing spray nozzle, so that spraying device can be repaired or replaced promptly to minimize any potential economic losses.

These objects are effectively addressed by the system and method of the invention for monitoring the performance of a spraying device. The spraying device has at least a first inlet for receiving a first fluid and a second inlet for receiving a second fluid. The spraying device further includes an internal mixing chamber where the first and second fluids are mixed. The mixture is transported from the mixing chamber to a nozzle aperture, which discharges the mixture to form a spray.

A mixture pressure sensor is disposed on the spraying device downstream of the mixing chamber to detect the pressure of the mixture. The input pressures of the first and second fluids entering the spraying device are also measured. A model is provided for describing a relationship between the actual mixture pressure and the actual pressures of the first and second fluids. The model can be based on physical insight or by a model structure provided through mathematical modeling. Based on the relationship provided by the model, a comparison process is used to determine whether the spraying device is functioning properly.

Additional features and advantages are explained in more detail below with the aid of preferred embodiments shown in the drawings, of which:

### BRIEF DESCRIPTION OF THE DRAWINGS

FIG. 1 is a schematic view of an embodiment of a spraying system in which the performance of an internal-mixing spraying device is monitored by a controller;

FIG. 2 is a cross-sectional top view of the spraying device in FIG. 1;

FIG. 3 is a cross-sectional side view of the spraying device with a mixture pressure sensor mounted thereon;

FIG. 4 is a flowchart showing a process of setting up and operating the system for monitoring the performance of the spraying device;

FIG. 5 is a flowchart showing a process of operating the system for monitoring the performance of the spraying device using models derived from physical laws;

FIG. 6 a schematic representation of the spraying system;

FIG. 7 a graph indicating the actual mixture pressure and the actual pressures of the first and second fluids for use in a training sequence;

FIG. 8 a graph indicating the actual mixture pressure and the actual pressures of the first and second fluids for use in a validation sequence;

FIG. 9 a graph indicating the correspondence, as determined by a second resealed model, between the actual mixture pressure and the actual pressures of the first and second fluids for the training sequence;

FIG. 10 a graph indicating the correspondence, as determined by the second resealed model of FIG. 9, between the actual mixture pressure and the actual pressures of the first and second fluids for the validation sequence;

FIG. 11 a graph indicating the correspondence, as determined by a third rescaled model, between the actual mixture pressure and the actual pressures of the first and second fluids for the training sequence; and

FIG. 12 a graph indicating the correspondence, as determined by the third rescaled model of FIG. 11, between the actual mixture pressure and the actual pressures of the first and second fluids for the validation sequence.

### DETAILED DESCRIPTION OF THE EMBODIMENTS

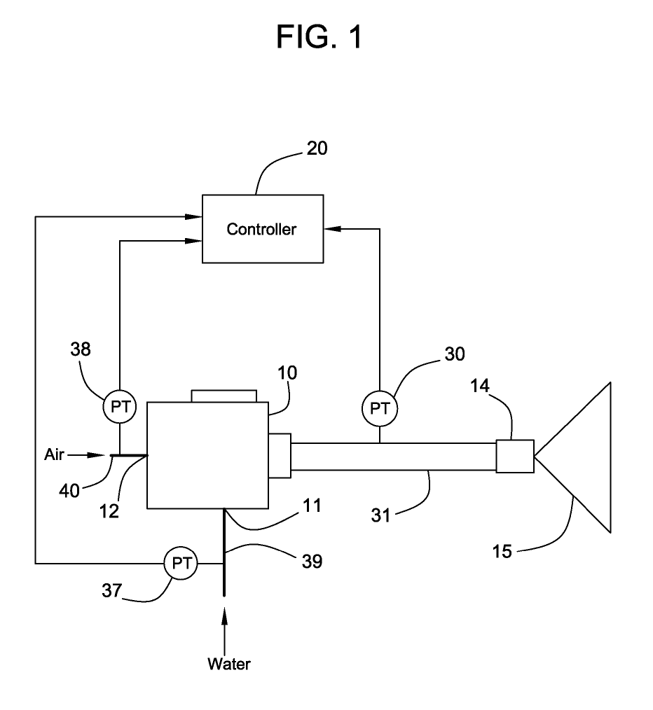

The present disclosure provides a system and method for monitoring the performance of a spraying device that receives different fluids and generates a spray of a mixture of the fluids in a given spray pattern. FIG. 1 shows an embodiment of such a spraying system, which includes a spraying device 10 and a controller 20 that monitors the performance of the spraying device in a way that will be described in greater detail below.

The spraying device 10 as shown in FIG. 1 has a first inlet 11 for a first fluid to enter the spraying device, and a second inlet 12 for a second fluid to enter the device. The two fluids are formed into a mixture inside the spraying device, and the mixture is ejected from an output nozzle end 14 of the spraying device in the form of a spray 15 with a desired spray pattern. The spraying device 10 may be used, for example, in a metal casting operation for providing cooling to the cast product, and in such an application the first and second fluids may be water and air, respectively.

In one application, a plurality of spraying devices are used to cool steel slabs in a casting process. In this application, the malfunction of one or more spraying devices, due to clogging or wear, can result in a non-homogenous temperature distribution of the slab. While the exterior of the slab is already in solid state, the interior is still liquid. The non-homogenous temperature distribution causes stress such that, when the temperature gradient along the slab exceeds a certain limit value, the solid outer material of the plate cracks and liquid steel can flow out of the slab. This results in serious damage and economical loss.

Even though the spraying device of the illustrated embodiment has two fluid inlets, it will be appreciated that more inlets can be added for applications where additional types of fluids are to be included in the mixture, and that the disclosure may be used to monitor the operation of a spraying device with three or more fluid inlets.

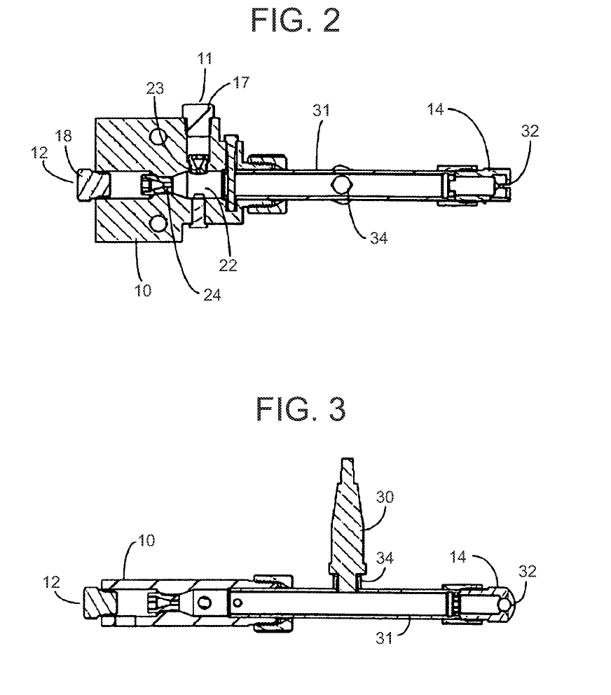

Referring to FIG. 2, the inlets 11, 12 are provided with fittings or connectors 17, 18 to receive pipes carrying the fluids. Inside the spraying device 10 is a mixing chamber 22. The first inlet 11 is in fluid communication with the mixing chamber 22 via a first orifice 23, and similarly the second inlet 12 is connected to the mixing chamber 22 via a second orifice 24. The first and second orifices are used to meter the flow of the fluids into the mixing chamber and preferably are calibrated so that the relationship between the flow rate of each fluid into the spraying device and the fluid pressure is well understood. The first and second fluids entering the inlets 11, 12 flow through the respective orifices 23, 24 and are merged in the mixing chamber 22, where they form a mixture, and the ratio of the fluids in the mixture is determined by the flow rates of the fluids into the nozzle. The mixture is carried by a tube 31 from the mixing chamber 22 to the nozzle end 14, where the mixture is discharged through a nozzle aperture 32 to form the spray.

In accordance with a feature of the disclosure, a pressure sensor 30 for sensing the pressure of the mixture formed in the spraying device 10 is disposed directly on the spraying device 10 to allow accurate measurements of the pressure. To that end, in the embodiment shown in FIG. 2, a port 34 is provided on the tube 31 connecting the mixing chamber to the nozzle aperture. The port 34 is configured to receive the pressure sensor 30, as shown in FIG. 3. Alternatively, the pressure sensor 30 may be mounted on the body of the spraying device 10 such that the pressure sensor is in direct fluid communication with the mixing chamber 22. The pressure sensor 30 is selected to be able to withstand the pressure of the mixture in the spraying device and to have a sufficient sensitivity to enable accurate readings of the mixture pressure. A suitable pressure sensor may be, for example, the Model OT-1 pressure transmitter made by WIKA Alexander Wiegand GmbH & Co. KG in Klingenberg, Germany.

Returning to FIG. 1, to provide readings of the pressures of the first and second fluids flowing into the spraying device 10, pressure sensors 37, 38 are provided in the pipe lines 39, 40 feeding the fluids to the spraying device 10. The pressure sensors 37, 38 preferably are located close to the inlets 11, 12 so their readings reflect accurately the pressure values of the fluids entering the spraying device. The three pressure sensors 37, 38, 30 are connected to the controller 20 such that the controller receives output signals of the pressure sensors, which represent the measured pressures of the first and second fluids and the mixture in the spraying device, respectively.

In accordance with a feature of the disclosure, the performance of the spraying device 10 is monitored by the controller 20 by comparing the measured actual pressure value of the mixture with a predicted mixture pressure, which is calculated using the measured pressures of the fluids as inputs. The predicted mixture pressure is calculated using an empirical formula that describes the relationship between the expected mixture pressure and the input pressures of the fluids. The exact form or shape of the formula can be determined/selected based on an understanding of the fluid dynamics involved and by finding a best fit of measured data with the formula.

By way of example, in one embodiment, the following formula with several linear parameters is used to predict the mixture pressure:
Pₘᵢₓ=b₁+b₂·Pₐᵢᵣ+b₃·P_{water}^{x}+b₄·Pₐᵢᵣ·P_{water}^{x}.
In this formula, Pₐᵢᵣ is the measured pressure for the air, P_{water} is the measured pressure for the water, and Pₘᵢₓ is the predicted pressure of the mixture in the spraying device. This formula contains four linear parameters b1, b2, b3, and b4, which are to be determined empirically. The exponent x is a fixed number, such as 0.5. It has been found that this formula provides a reasonably good model for predicting the mixture pressure based on given input fluid pressures. It will be appreciated, however, that this formula is only one of different forms of formulas that may be used, and the disclosure is not limited to the particular form of this formula. Also, although the use of a linear formula has the advantage of computational efficiency, non-linear formulas may also be used to model the mixing behavior of the spraying device if such a formula can more accurately predict the mixture pressure and if the controller has sufficient computational power to carry out calculations involved in handling the non-linear formulas.

In accordance with an aspect of the disclosure, the parameters in the formula for calculating the mixture pressure can be learned by the controller 20 when the spraying device is “on-line,” i.e., installed in its intended operating position. In the learning process, the input pressures of the fluids are varied, and the measured values of the pressures of the first and second fluids and the mixture are used as inputs for determining the parameters. This learning operation is preferably performed when the spraying device is first put in service, under the assumption that the nozzle is performing correctly as designed during this phase. Once the parameters of the formula for predicting the mixture pressure are determined in this learning phase, they can be used by the controller 20 in the subsequent operations of the spraying device to calculate the expected mixture pressure based on measured input pressures of the fluids. The expected mixture pressure value can then be used with the measured actual mixture pressure in a comparison process to determine whether the spraying device is operating properly.

In one embodiment, the learning of the parameters of the empirical formula is done via a recursive least square parameter estimation algorithm, as set forth in the following formulas:
\hat{θ}(t)=\hat{θ}(t−1)+K(t(y(t)−ŷ(t))
ŷ(t)=ψ^{T}(t)\hat{θ}(t−1)
K(t)=Q(t)ψ(t)

$$Q ( t ) = P ( t ) = \frac{P ( t - 1 )}{λ + {Ψ ( t )}^{T} P ( t - 1 ) Ψ ( t )}$$

$$P ( t ) = \frac{1}{λ} ( P ( t - 1 ) - \frac{P ( t - 1 ) ψ ( t ) {ψ ( t )}^{T} P ( t - 1 )}{λ + {Ψ ( t )}^{T} P ( t - 1 ) Ψ ( t )} ) ,$$

where y(t)=measured mixture pressure at the moment t;
ŷ(t)=prediction of measured mixture pressure at the moment t based on information before the moment t;
P(t)=inverse covariance matrix;
Ψ(t)=input values (input measurements, air and water pressure)
θ(t)=parameter vector (b1, b2, b3, b4)
λ=forgetting factor (=1)

After the parameters in the mixture pressure formula are determined using the recursive least square algorithm, the formula is ready to be used by the controller 20 for monitoring the performance of the spraying device. When the controller 20 detects a significant deviation of the measured mixture pressure in the spraying device from the predicted or expected mixture pressure and if the deviation lasts for a sufficiently long time, it generates a fault signal to get the attention of the operator of the processing line so that the possible cause of the deviation can be investigated, and the spraying device may be repaired or replaced if necessary.

In one embodiment, a combination of static and dynamic techniques is used to determine if a fault signal should be generated. In this fault determination process, measurements are taken periodically at regular intervals. For each measurement interval, a static error state Si at a certain moment in time (ti) is calculated as follows:

Pₘₘᵢ: measured mixed pressure at time i

P_{abs}: maximum absolute error

Eᵣₑₗ: maximum relative error (in %)
Absolute fault: Pₑᵣᵣᵢ=Pₘᵢₓᵢ−Pₘₘ_{ᵢ}
Relative fault 1: Pᵣ₁ᵢ=Pₘᵢₓ_{ᵢ}·Eᵣₑₗ
Relative fault 2: Pᵣ₂_{ᵢ}=Pₘₘ_{ᵢ} ·Eᵣₑₗ.
The error state at time tᵢ is: Sᵢ=(|Pₑᵣᵣ_{ᵢ}|>P_{abs})+(|Pₑᵣᵣ_{ᵢ}|>Pᵣ₁_{ᵢ})+(|Pₑᵣᵣ_{ᵢ}|>Pᵣ₂_{ᵢ}).

Thus, the static error state Sᵢ is determined based on three threshold levels: a pre-selected fixed level P_{abs}, and two variable levels Pᵣ₁ᵢ and Pᵣ₂ᵢ that depend on the values of the measured input liquid pressures. The values of P_{abs} and Eᵣₑₗ are chosen depending on the accuracy of the sensors and the stability of the signals. A good choice for P_{abs} is, for example, 3 times the standard deviation on Pₑᵣᵣ, measured on a large number of points (e.g. 1000) in the normal operating range of the nozzle. In that case, the P_{abs} is calculated based on the following formulas:

$${P}_{abs} = 3 \cdot \sqrt{{\sum }_{i = 0}^{i = n - 1} \frac{{( {P}_{{err}_{i}} - μ )}^{2}}{n}}$$

$$μ = {\sum }_{i = 0}^{i = n - 1} \frac{{P}_{{err}_{i}}}{n} ,$$

The type of error causing the pressure deviation depends on the sign of Pₑᵣᵣ. If the sign is positive, the measured actual pressure is lower than the predicted pressure. This may happen if either the calibrated orifices are blocked or the tip is worn out. On the other hand, if the sign is negative, the measured pressure is higher than the predicted pressure, which may occur if either the calibrated orifices are worn out or the tip is blocked. Thus, based on the sign of Pₑᵣᵣ, the possible cause of the pressure deviation can be determined.

The dynamic error state (Dᵢ) is then calculated using the following algorithm:

If Sign(Pₑᵣᵣᵢ)≠Sign(Pₑᵣᵣᵢ₋₁), then Dᵢ is false (valid situation).

If Sᵢ is false for at least T_{good}, then Dᵢ is false (valid situation).

If Sᵢ is true for at least T_{bad}, then Dᵢ is true (fault detected).

In this determination, Dᵢ is set to be true only when the static error state Sᵢ has been true for a pre-selected time period T_{bad}. This is done to reduce the likelihood that the measured pressure deviation is caused by noise or fluctuation in the liquid pressures or the sensed pressure signals. If the dynamic error state Dᵢ is true, the controller 20 determines that a fault situation is found, and generates a fault signal to indicate that the spraying device is not functioning properly.

The following factors using in the decisions above have to be chosen, and are depending on the dynamics of the system:

T_{good}: time needed with good samples before the situation is evaluated as valid;

T_{bad}: time needed with bad samples before the situation is evaluated as faulty.

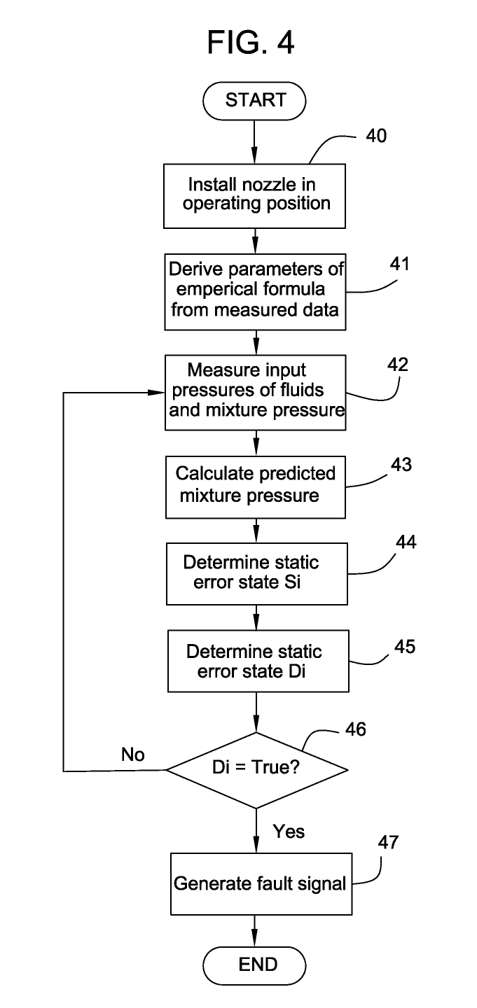

The process of setting up the spraying device 10 and the controller 20 and the subsequent monitoring operation are summarized in the flowchart in FIG. 4. First, the spraying device is set up in its intended operating position (step 40). A learning process is then performed under the control of the controller to determine the parameters in the empirical formula to be used for predicting the mixture pressure (step 41). Thereafter, during the normal operations of the spraying device, the controller continuously monitors the performance. For each detection cycle, the controller receives measured pressure signals for the input liquids and the mixture from the pressure sensors (step 42). The controller uses the measured input liquid pressures as inputs for the empirical formula to calculate the predicted mixture pressure (step 43). A static error state Sᵢ for the detection cycle is determined based on the measured and calculated pressure values (step 44). A dynamic error state Dᵢ is then calculated based on the present and past values of the static error state variable (step 45). If the dynamic error state Dᵢ is true (step 46), the controller generates a fault signal indicating that the spraying device is not functioning properly (step 47).

In accordance with an aspect of the disclosure, the performance of a spraying device is monitored by a controller using an algorithm based on a formula having left- and right-hand sides. The formula describes and/or models an observed phenomena of the spraying device. The formula can be empirical, mathematical, or based on physical characteristics of the device. Both the left- and right-hand side of the formula use measured quantities of the spraying process and parameters, which are determined. For example, the measured quantities can include sensed pressure, i.e., Pₐᵢᵣ, P_{water} and Pₘᵢₓ, as described above. The parameters can be determined by a calibration experiment or by some knowledge, as discussed in detail below.

During a monitoring operation, the measured quantities, e.g., Pₐᵢᵣ, P_{water} and Pₘᵢₓ, are detected on a regular basis and verified via the formula. When these measured quantities are applied in the formula, the difference between the left- and right-hand side of the formula can be used to determine whether the spraying device 10 is working properly. For example, if the difference between the left- and right-hand side of the formula is smaller than a maximum error bound, which accounts for noise, inaccuracies of the formula, and imprecise parameters, then the spraying device 10 is considered to be functioning properly. However, if the difference between the left- and right-hand side of the formula is larger than the maximum error bound, then the spraying device 10 is considered to be functioning abnormally.

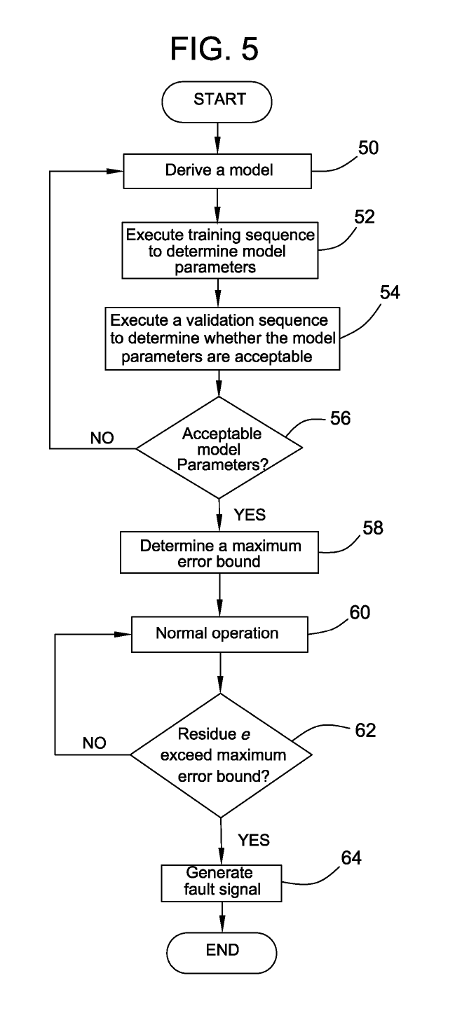

While such formulas can be achieved in various ways, such as empirically or mathematically, FIG. 5 illustrates a process for deriving a formula, having left- and right-hand sides, based on the physical properties of the spraying device 10. FIG. 5 also illustrates a process of using the derived formula to monitor the spraying device 10. First, in step 50, the system derives an appropriate formula. For deriving the formula, the physical attributes of the spraying device 10 can be observed. For example, the formula can be derived through observation of the energy behavior of the spraying device.

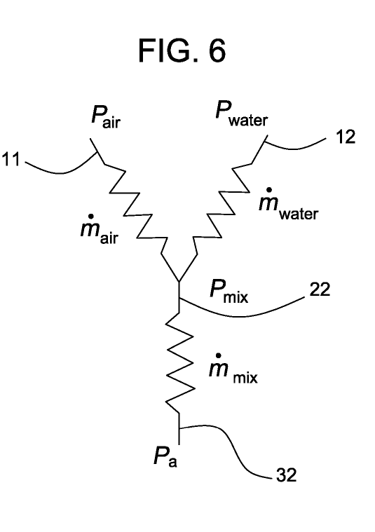

Specifically, the spraying device 10 may be modeled by ignoring energy stored in the nozzle 14 during operation of the spaying device. Instead, the device is modeled via energy dissipated therefrom. Based on a conservation of energy, the behavior of the spaying device 10 is modeled through an electrical schematic representation of the spraying device, such as by using a set of resistor elements as illustrated in FIG. 6. Air and liquid supplied at certain pressures Pₐᵢᵣ and P_{water}, to inlets 11, 12, respectively, are modeled as an electrical resistance to the mixing chamber 22. From the mixing chamber 22, the fluid, at a certain pressure, Pₘᵢₓ, flows through the nozzle aperture 32 to the outside, at atmospheric pressure, Pₐ. Based on the law of conservation of mass, the following formula representing the relationship between the mass flow of the input and output fluids across the spraying device 10 can be derived:
\dot{m}ₐᵢᵣ+\dot{m}_{water}=\dot{m}ₘᵢₓ,
where \dot{m}ₐᵢᵣ=mass flow rate of the air supplied to the mixing chamber;

\dot{m}_{water}=mass flow rate of the water supplied to the mixing chamber; and

\dot{m}ₘᵢₓ=mass flow rate of mixture exiting the mixing chamber to the atmosphere.

For deriving a formula for monitoring the spraying device 10, the relationship between the mass flow rates and the pressures are considered. In a preferred embodiment, the system determines the mass flow rates, \dot{m}ₐᵢᵣ, \dot{m}_{water}, and \dot{m}ₘᵢₓ, as a function of the measured pressures, Pₐᵢᵣ, P_{water} and Pₘᵢₓ. The relationship between the mass flow rates and the pressures depends on, for example, whether the flow is laminar or turbulent and whether the fluid is compressible or not. Laminar flow is characterized as a highly ordered flow, where the particles retain the same relative positions in successive cross sections. In laminar flow, the fluid flows in layers which interact through a significant shear stress. On the other hand, turbulent flow is a highly disordered flow where the particles move in all directions. The effect of the viscous forces, which causes the order in laminar flow are much less important in turbulent flow. The type of flow is determined by the Reynolds number, which is a dimensionless number, making the ratio between the inertial forces and the viscous forces. Turbulent flows are characterized by a high Reynolds number, while laminar flows are characterized by a low Reynolds number.

For turbulent flows, where the shear stress, which results in friction, is negligible, the relation between the pressures and the mass flow rate is derived via the Bernoulli formula, resulting in following formula:

$$\dot{m} = \frac{CA ɛ}{\sqrt{1 - {β}^{4}}} \sqrt{2 ρ ( {P}_{1} - {P}_{2} )} ,$$

where the discharge coefficient C is a correction factor on the Bernoulli formula and accounts for the contraction of the flow in the orifice, factor A is the cross sectional area of the orifice, coefficient β is the ratio of the orifice diameter of the inlet to the diameter of the outlet, pressures P1 and P2 are respectively the upstream and downstream pressures, symbol ρ is the upstream mass density of the fluid, and the expansibility factor ε accounts for the compressibility of the fluid.

Analytical computation of the discharge coefficient C is not straightforward, especially for m mix, which is a two phase fluid. Norms, such as ISO 5167, B.S. 1042 and the Russian norm GOST 8.563-97, can be used in the formulas to calculate the discharge coefficient C. It will also be appreciated that, when monitoring the spraying device 10, individual knowledge of these coefficients is not necessary and all coefficients can be grouped in a single constant.

For incompressible fluids, the expansion factor ε=1. However, for compressible fluids, the expansibility factor ε is calculated by the following expression:

$$ɛ = \sqrt{\{ ( \frac{γ}{γ - 1} ) {( \frac{{P}_{2}}{{P}_{1}} )}^{2 / γ} \times [ \frac{1 - {( {P}_{2} / {P}_{1} )}^{( γ - 1 ) / γ}}{1 - ( {P}_{2} / {P}_{1} )} ] \times [ \frac{1 - {β}^{2}}{1 - {{β}^{2} ( {P}_{2} - {P}_{1} )}^{2 / γ}} ] \}} ,$$

where γ is the specific heat ratio. In cases where the temperature range is limited, the specific heat ratio γ is a constant and approximately 1.4.

The formulas for monitoring the performance of the spraying system 10 can be derived based on the above formulas, which represent the relationship between the mass flow rates and the pressures of the input and output fluids. An exemplary first formula for modeling the spraying device 10 can be used in cases where no compressibility is assumed. In this first formula, the Bernoulli formula reduces to the following:
\dot{m}=R\sqrt{P₁−P₂},
which describes the relationship between the mass flow rate and the pressure difference across the orifice. In this formula, the constant R groups all coefficients of the Bernoulli formula, and the coefficients are assumed constant. The inverse of R has the physical interpretation of a resistance. Incorporating this formula in the law of conservation of mass formula, results in the first formula for modeling the spraying device 10. The first formula follows:
R₁\sqrt{Pₐᵢᵣ−Pₘᵢₓ}+R₂\sqrt{P_{water}−Pₘᵢₓ}=R₃\sqrt{Pₘᵢₓ−Pₐ},
where the factors R₁, R₂, and R₃ are model parameters.

An exemplary second formula for monitoring the spraying device 10 can be used in cases that involve incompressible flows, such as water. The second formula can also be used in cases where the flow is turbulent. In this second formula, the Bernoulli formula becomes:
\dot{m}=R(P₁−P₂)^{1/α},
where α is an exponent which takes on values between 1 and 2. For turbulent flows, α=1, and for laminar flows, α=2. Flows between these extremes can yield intermediate values of α.

Incorporating this formula in the law of conservation of mass formula results in the second formula for modeling the spraying device 10. The second formula follows:
R₁(Pₐᵢᵣ−Pₘᵢₓ)^{1/α}^{₁}+R₂(P_{water}−Pₘᵢₓ)^{1/α}^{₂}=R₃(Pₘᵢₓ−P_{α})^{1/α}^{₃},
where the factors R₁, R₂, and R₃ are model parameters.

An exemplary third formula for monitoring the spraying device 10 can be used in cases where it is appropriate to assume that all flows are turbulent, and where it is appropriate to consider the compressibility of the flows. Because the third formula considers compressibility, the expansibility factor ε should be included. In B.S. 1042 and ISO 5167, for certain conditions, the theoretically derived expression of the compressibility factor ε can be approximated by the following regression formula:

$$ɛ = 1 - ( 0.41 + 0.35 {β}^{4} ) \frac{1}{γ} \frac{Δ P}{{P}_{1}} ,$$

where ΔP is the pressure difference between the upstream and the downstream pressure. P₁ in this regression formula is an absolute pressure, and, in cases where relative pressures are used, the atmospheric pressure should be added to P₁. In the third formula, this regression formula is incorporated in the Bernoulli formula, resulting in the following:

$$\dot{m} = {R}_{1} \sqrt{{P}_{1} - {P}_{2}} - {R}_{2} \frac{{( {P}_{1} - {P}_{2} )}^{3 / 2}}{{P}_{1}} ,$$

where R₁ and R₂ are model parameters.

Because P₁ and P₂ represent the upstream and the downstream pressures, R₂ is generally smaller than R₁. It can be assumed that the flows \dot{m}ₐᵢᵣ and \dot{m}ₘᵢₓ are compressible and the flow \dot{m}_{water} is incompressible. Accordingly, the third formula includes this modified Bernoulli formula for modeling the compressible flows \dot{m}ₐᵢᵣ and \dot{m}ₘᵢₓ, and the third formula includes the modified Bernoulli formula of the first model for modeling the incompressible flow \dot{m}_{water}. The third formula follows:

$${R}_{1} \sqrt{{P}_{air} - {P}_{mix}} - {R}_{2} \frac{{( {P}_{air} - {P}_{mix} )}^{3 / 2}}{{P}_{air}} + {R}_{3} \sqrt{{P}_{water} - {P}_{mix}} = {R}_{4} \sqrt{{P}_{mix} - {P}_{a}} - {R}_{5} \frac{{( {P}_{mix} - {P}_{a} )}^{3 / 2}}{{P}_{mix}} ,$$

where the factors R₁, R₂, R₃, R₄, and R₅ are model parameters.

Referring again to FIG. 5, after an appropriate formula for modeling the spraying device is derived, a training sequence is then performed under the control of the controller 20 to determine the model parameters (step 52). Because, in this example, the formula is derived from physical laws, the parameters can be determined analytically. For example, the model parameters can be determined by a training sequence using numerical optimization. For numerical optimization, the formula is over determined. Therefore, a resealing is performed. Resealing for the first exemplary formula follows:
K₁\sqrt{Pₐᵢᵣ−Pₘᵢₓ}+K₂\sqrt{P_{water}−Pₘᵢₓ}=\sqrt{Pₘᵢₓ−Pₐ},
where parameters K₁ and K₂ are the resealed model parameters. Rescaling for the second exemplary formula follows:
K₁(Pₐᵢᵣ−Pₘᵢₓ)^{1/α}^{₁}+K₂(P_{water}−Pₘᵢₓ)^{1/α}^{₂}=(Pₘᵢₓ−Pₐ)^{1/α}^{₃},
where parameters K₁ and K₂ are the resealed model parameters. Resealing for the third exemplary formula follows:

$${K}_{1} \sqrt{{P}_{air} - {P}_{mix}} - {K}_{2} \frac{{( {P}_{air} - {P}_{mix} )}^{3 / 2}}{{P}_{air}} + {K}_{3} \sqrt{{P}_{water} - {P}_{mix}} = {K}_{4} \sqrt{{P}_{mix} - {P}_{a}} - \frac{{( {P}_{mix} - {P}_{a} )}^{3 / 2}}{{P}_{mix}} ,$$

where parameters K₁, K₂, K₃, and K₄ are the resealed model parameters.

Model parameters, e.g., K₁, K₂, K₃, and K₄, are determined on a training sequence of N samples and by minimizing following optimization criterion:

$${\sum }_{i - 1}^{N} {e}_{i}^{2} .$$

For the first and third resealed formula, the problem is linear in the parameters and standard analytical solutions can be used. For the second resealed formula, optimization is nonlinear in the parameters. Accordingly, for the second resealed formula, the optimization is performed using a computer. Because the first and third resealed formulas are linear in the parameters, the local optimum is also the global optimum and the optimization problem is called convex. The result for the second resealed formula is determined by the selection of the starting values. Assuming that all factors in the second resealed formula contribute in a similar way, then K₁ and K₂ have the order of magnitude 1. And from a physical point of view, the exponents α₁ and α₂ should be between 1 and 2.

Referring again to FIG. 5, after the training sequence has been executed to determine the parameters of the formula for modeling the spraying device 10, a validation sequence is executed to determine whether the parameters are acceptable (Step 54). To execute the validation sequence, the controller 20 applies actual measurements of Pₐᵢᵣ, P_{water} and Pₘᵢₓ that it receives from sensors 38, 37, 30 in the formula to determine whether a good correspondence occurs between the left- and right-hand side of the formula. If the correspondence is bad, the controller 20 returns to step 50, where another formula is derived. If, however, the correspondence is good, the controller 20 continues (step 56).

Next, the controller 20 determines the maximum error bound (step 58). In theory, the left-hand side of the formula, which models mass flow into the spraying device 10, should be equal to the right-hand side of the formula, which models mass flow out of the spraying device. However, in reality, the left- and right-hand sides may not be equal due to noise and model errors. A residue e represents this difference between the right- and left-hand sides, and the maximum error bound is the largest acceptable residue e. If the residue e exceeds the maximum error bound, then the spraying device 10 is malfunctioning and needs to be replaced or repaired.

There are several ways to determine these maximum error bounds. In accordance with an aspect, a training sequence is performed such that the maximum error bounds can be learned by the controller 20 when the spraying device 10 is “off-line.” For example, during performance of the training sequence for determining the model parameters, the standard deviation σ for the residue e can be calculated using the following equation:

$${σ}^{2} = {\sum }_{i - 1}^{N} {e}_{i}^{2} .$$

The maximum error bounds can be based on the determined standard deviation σ. An exemplary maximum error bound can be three times the standard deviation, i.e., 3σ.

In accordance with another aspect of the invention, the training sequence can be performed when the spraying device 10 is “on-line.” For example, using the following equation:

$${σ}_{k}^{2} = \frac{( k - 1 )}{k} {σ}_{k - 1}^{2} + \frac{1}{k} {e}_{k}^{2} ,$$

a new measurement is collected each time an interval k occurs. In operation, k can become very large, which may result in an overflow. To avoid problems related to overflow, the factor (k−1)/k is replaced by a fixed factor γ. Accordingly, Formula 16 becomes:
σₖ²=λσ²ₖ₋₁+(1−λ)eₖ²,
such that factor γ has the interpretation of a forgetting factor.

After determining the maximum error bound, the controller proceeds to normal operation (step 60). During normal operation, the controller 20 continuously monitors the performance of the spraying device 10. In doing so, the controller receives measured pressure signals for the input liquids and the mixture from the pressure sensors. The controller applies the measured pressure signals in the derived formula to determine whether the residue e (e.g., the difference between the right- and left-hand side of the formula) exceeds the maximum error bound (step 62). If the residue e exceeds the maximum error bound, the controller generates a fault signal indicating that the spraying device is not functioning properly (step 64). If the residue e does not exceed the maximum error bound, then the controller 20 continues normal operation.

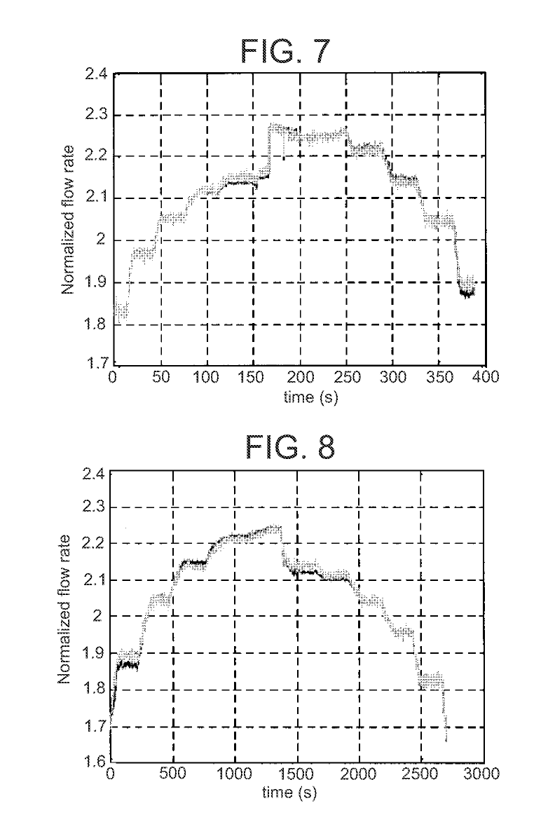

In operation, the controller 20 employs one of the previously discussed first, second, or third formulas, each having left- and right-hand sides, for monitoring the spraying device 10. FIGS. 7 and 8 indicate actual Pₐᵢᵣ, P_{water} and Pₘᵢₓ values applied to an exemplary spraying device 10 during operation. First, a training sequence is performed for determining the parameters for the first, second, and third resealed formulas. And if, for one of the first, second, and third formulas, a good correspondence occurs between the left- and right-hand side of the formula, then the quality of the model parameters are evaluated on a validation sequence. For the first resealed formula, a bad correspondence is obtained between the left- and right-hand side.

When the exponent α is constrained between 1 and 2, the second rescaled formula also provides a bad correspondence between the left- and right-hand side. The result of the optimization renders values of αₜ on the constraints. However, when this physical constraint on a is released, a better correspondence between the left- and right-hand side is obtained for the training sequence. The computation of the optimal parameter values is a non-convex problem and the outcome of the optimization depends on the initial values of the parameters of second rescaled formula. After releasing the constraint on at the parameter space from which the initial values of K₁ and K₂ are selected is between 0 and 1, and for the αₜ parameters between 1 and 2. During the training sequence itself, the only constraint is that all parameter values remain positive. It turns out that the result is sensitive to the initial selection of the parameters and that the algorithm tends to put the exponents αₜ, close to zero.

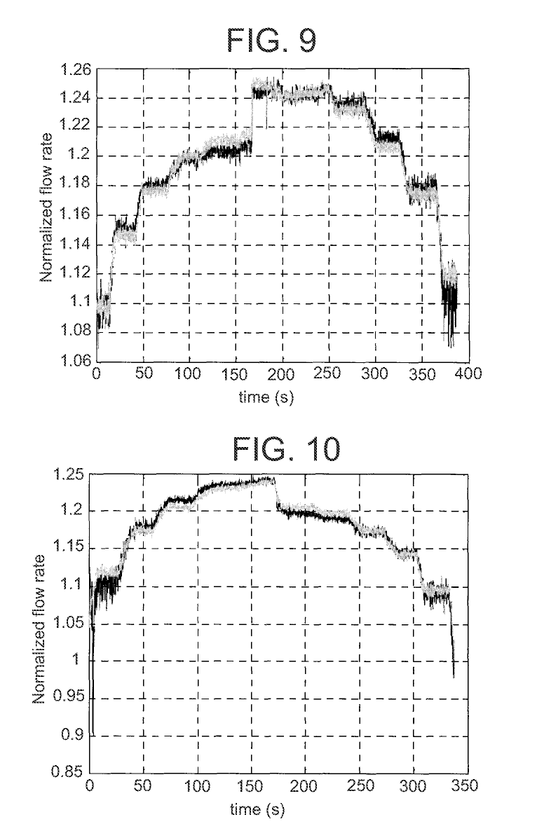

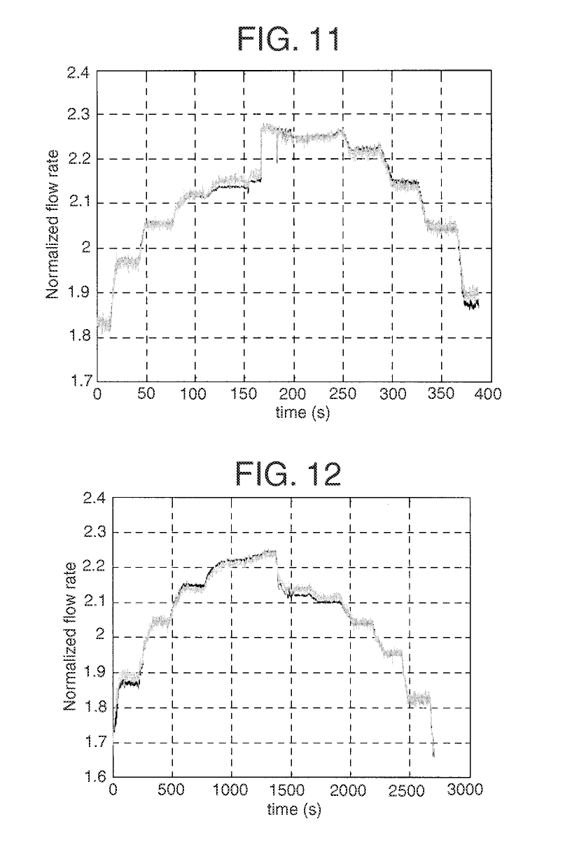

The training and validation sequences for the second formula are illustrated in FIGS. 9 and 10. FIG. 9 is a graph indicating the correspondence, as determined by a second rescaled formula, between the actual mixture pressure and the actual pressures of the first and second fluids for the training sequence. FIG. 10 is a graph indicating the correspondence, as determined by the second rescaled formula of FIG. 9, between the actual mixture pressure and the actual pressures of the first and second fluids for the validation sequence.

For the third rescaled formula, good correspondence between the left- and right-hand side were obtained for the training as well as the validation sequence. The results are even better than the results obtained from the second resealed formula. Note that the third resealed formula assumes compressible and turbulent flow, whereas in the second resealed formula, compressibility is not taken into account but the flow can be either laminar, turbulent or something in between. Moreover, the second resealed formula delivers good results when the exponents at take on non-physical values. This suggests that the flows in the nozzle are basically turbulent and that the compressibility is an important factor.

The training and validation sequences for the third resealed formula are illustrated in FIGS. 9 and 10. FIG. 9 is a graph indicating the correspondence, as determined by a third rescaled formula, between the actual mixture pressure and the actual pressures of the first and second fluids for the training sequence. FIG. 10 is a graph indicating the correspondence, as determined by the third resealed formula of FIG. 9, between the actual mixture pressure and the actual pressures of the first and second fluids for the validation sequence.

Based on the relationship provided by the third resealed formula, this example also demonstrates a comparison process for determining whether a spraying device 10 is functioning properly. Computing the standard deviation σ, according to the above-described formula for calculating the standard deviation σ, delivers 0.0098 for the training sequence and 0.0119 for the validation sequence. These values are less than 1% with respect to the average value generated by the left- or right-hand side of third resealed formula. For nozzle monitoring purposes, it should be checked whether the instantaneous error between the left- and right-hand side of the third resealed formula is within maximum error bounds. When this maximum error bound is taken at 3%, the nozzle 10 is always classified as in tact. After damaging the nozzle 10, a larger mismatch between the left-hand and right-hand side will be observed and the nozzle 10 will be classified as damaged, and a fault signal will be generated to get the attention of the operator.

In accordance with an optional feature of the disclosed embodiment, a plurality of spraying devices 10 are provided in communication with a single controller 20. The system includes a manifold that supplies air and water to each of the spray devices 10. Accordingly, all devices 10 are working with the same inlet water and inlet air pressure. Additionally, each spaying device 10 in the system has standard size orifices. The devices 10 of the system can have varying tube lengths because the length of the tube 31 does not affect the relationship between the mixing pressure and the inlet water and air pressure. All spraying devices 10 of the system have the same pressure in their respective mixing chambers because all of the devices 10 are supplied from the same manifold and because all of the spaying devices 10 have standard size orifices. Accordingly, the theoretical relation is the same for all devices 10.

The controller 20 can be programmed to identify malfunctioning spraying devices 10 within the system. To do so, the controller 20 monitors the actual pressure of the mixture within each device 10. If a single device 10 has a much different mixture pressure than the other devices 10, then the controller identifies that device as being faulty.

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

1. A method for monitoring performance of a spraying device receiving at least first and second fluids and generating a spray of a mixture of said at least first and second fluids, comprising:
measuring a first input pressure for the first liquid and a second input pressure for the second liquid entering the spraying device;
measuring an actual pressure of a mixture of the first and second fluids formed in the spraying device;
providing a formula having left hand and right hand sides for modeling a relationship between the actual pressure of the mixture and the first and second input pressures; and
determining, based on a comparison process of the right hand and left hand side of the formula, whether the spraying device is functioning properly.

2. A method as in claim 1, further comprising the step of deriving a plurality of parameters for the formula based on the first and second input pressures and the actual pressure of the mixture.

3. A method as in claim 2, further comprising the step of determining whether the parameters are accurate.

4. A method as in claim 2, further comprising the step of determining a maximum error bound.

5. A method as in claim 4, wherein the maximum error bound is based on a standard deviation for a difference between the actual pressure of the mixture and the first and second input pressures.

6. A method as in claim 4, wherein the spraying device is functioning properly when a difference between the left hand and right hand side of the formula is within the maximum error bound.

7. A method as in claim 4, further comprising the step of generating a fault signal when a difference between the left hand and right hand side of the formula is outside the maximum error bound.

8. A method as in claim 1, wherein the left hand side of the formula is a prediction of the actual pressure of the mixture.

9. A method as in claim 1, wherein the formula is based on the law of conservation of mass.

10. A spraying system comprising:
a spraying device having at least a first inlet for a first fluid and a second inlet for a second fluid, an internal mixing chamber for mixing the first and second fluids to form a mixture inside the spraying device, and a nozzle end having an aperture for discharging the mixture to form a spray;
a mixture sensor for measuring an actual mixture pressure of the mixture in the spraying device;
a first input sensor for measuring a pressure of the first fluid entering the spraying device;
a second input sensor for measuring a pressure of the second fluid entering the spraying device; and
a controller for monitoring performance of the spraying device, the controller being connected to the mixture sensor and first and second input sensors for receiving readings indicative of measured pressures of the mixture and the first and second fluids, the controller being programmed to use a formula having left and right hand sides for determining whether the spraying device is functioning properly.

11. A spraying system as in claim 10, wherein the controller is configured to derive a plurality of parameters for the formula based on measured values of the first and second input pressures and the actual pressure of the mixture.

12. A spraying system as in claim 11, wherein the controller is configured to determine whether the parameters are accurate.

13. A spraying system as in claim 10, wherein the controller is configured to determine a maximum error bound.

14. A spraying system as in claim 13, wherein the maximum error bound is based on a standard deviation for a difference between the actual pressure of the mixture and the first and second input pressures.

15. A spraying system as in claim 13, wherein the spraying device is functioning properly when a difference between the left hand and right hand side of the formula is within the maximum error bound.

16. A spraying system as in claim 13, wherein the controller is configured to generate a fault signal when a difference between the left hand and right hand side of the formula is outside the maximum error bound.

17. A spraying system as in claim 10, wherein the left hand side of the formula is a prediction of the actual pressure of the mixture.

18. A spraying system as in claim 10, wherein the formula is based on the law of conservation of mass.

19. A spraying system as in claim 10, wherein the model is configured to describe the physical relationship between the actual pressure of the mixture and the first and second input pressures.

20. A spraying system comprising:
a plurality of spraying devices, each spraying device having at least a first inlet for receiving a first fluid at a first fluid pressure and a second inlet for receiving a second fluid at a second fluid pressure, an internal mixing chamber for mixing the first and second fluids to form a mixture inside the spraying device, and a nozzle end having an aperture for discharging the mixture to form a spray, the aperture of each spraying device having a common size;
a mixture sensor coupled to each of the spraying devices for measuring an actual mixture pressure of the mixture in the spraying device; and
a controller for monitoring performance of the spraying devices, the controller being connected to the mixture sensor of each spraying device for receiving the actual mixture pressure, the controller being programmed generate a fault signal when the actual mixture pressure of one of the plurality of spraying devices deviates an amount from the actual mixture pressure of the other spraying devices.
